(19) United States
(12) Patent Application Publication
(10) Pub. No.: US 2022/0134484 A1
(43) Pub. Date: May 5, 2022

(54) METHOD AND DEVICE FOR ASCERTAINING THE ENERGY INPUT OF LASER WELDING USING ARTIFICIAL INTELLIGENCE

(71) Applicant: Robert Bosch GmbH, Stuttgart (DE)

(72) Inventors: Alexander Ilin, Ludwigsburg (DE); Andreas Michalowski, Renningen (DE); Anna Eivazi, Renningen (DE); Heiko Ridderbusch, Schwieberdingen (DE); Julia Vinogradska, Stuttgart (DE); Petru Tighineanu, Ludswigsburg (DE); Alexander Kroschel, Renningen (DE)

(21) Appl. No.: 17/510,215

(22) Filed: Oct. 25, 2021

(30) Foreign Application Priority Data
Nov. 3, 2020 (DE) 10 2020 213 816.8

(51) Int. Cl. B23K 31/12; B23K 26/21; B23K 26/70

(52) U.S. Cl. CPC B23K 31/125; G06N 20/00; B23K 26/702; B23K 26/21

(57) ABSTRACT

A method for training a data-based model to ascertain an energy input of a laser welding machine into a workpiece as a function of operating parameters of the laser welding machine. The training is carried out as a function of an ascertained number of spatters.

### FIELD

The present invention relates to a method for training a data-based model, a method for setting operating parameters of a laser welding machine, a test stand, a computer program, and a machine-readable memory medium.

### BACKGROUND INFORMATION

Laser welding is an established manufacturing method for setting up connections of workpieces made of different materials. A focused laser beam is applied to the workpieces to be connected. Due to the very high intensity, the absorbed laser energy results in very rapid local heating of the workpiece materials, which results in a common melt bath formation on short time scales and in a very spatially localized manner. After the solidification of the melt bath, a connection forms between workpieces in the form of a weld seam.

To meet requirements for the connection strength (and fatigue strength), it may be desirable for the geometry of the weld seam not to fall below a minimal permissible weld seam depth and a minimal permissible weld seam width. To achieve the desired weld seam shapes, the process parameters may be selected in such a way that rapid and local heating of the materials by the laser radiation results in vaporization in the melt bath. The molten material is expelled from the melt bath by the process-related explosively generated vapor pressure and large pressure gradients linked thereto or also by externally supplied gas flows. The occurring metallic spatters (so-called weld spatters) may result in a reduction of the component quality and/or may require production interruptions for cleaning the laser welding facility, which causes a significant increase of the manufacturing costs.

In the case of laser welding, the process development (process optimization with the goal of minimizing the weld spatter) is also very experimental in nature, because the numerous highly dynamic interacting physical effects are not able to be modeled with sufficient accuracy.

One challenge in the modeling in this case is that the workpiece characteristic data are often not known for the relevant pressures and temperatures. The manufacturing tolerances of the individual workpieces and the variations in the materials may also influence the formation of the weld spatter very highly. Greatly simplified models are in fact available, using which a certain prediction of the achieved weld seam shape is possible with given process parameters and in certain parameter ranges. However, a reliable prediction regarding quality properties, for example, solidified weld spatter, is not possible using these models.

Therefore, for example, some process parameters are set to empirically based values and only relatively few parameters are varied at all. The actually achievable optimum is generally not found.

### SUMMARY

In the case of laser welding, the achievable precision and productivity is very highly dependent on the set process parameters, the workpiece material used, and sometimes also its geometry.

Because there are many settable process parameters (which are often dependent on time and location), such as laser power, focus diameter, focus position, welding speed, laser beam inclination, circular path frequency, and process inert gas, the optimization of the process parameters is a lengthy process which requires very many experiments. Because, on the one hand, many workpieces or components are required for these experiments and, on the other hand, the evaluation (manufacturing of cross sections for measuring the weld seam geometry) is also complex, it is desirable for the number of the required experiments to be reduced to a minimum.

Example embodiments of the present invention may have the advantage that a prediction of the characteristic of the laser welding process as a function of the selected process parameters is possible although the variable determining the characteristic is not accessible to a direct measurement.

Further aspects of the present invention are disclosed herein. Advantageous refinements of the present invention are disclosed herein.

### SUMMARY

As described, it is necessary in particular for efficient and targeted optimization of the process parameters to predict with the aid of a model as a function of detected values during welding experiments how the characteristic of the laser welding process will change as a function of the process parameters.

A decisive variable for characterizing the laser welding process is the energy input of the laser welding machine into a processed workpiece or a temperature distribution during laser welding which is closely linked thereto. Such a variable characterizing the energy input is not easily accessible to a direct measurement. However, it has been recognized that this variable closely correlates with a number of spatters which arise during the laser welding.

In a first aspect of the present invention, it is therefore provided that a data-based model which ascertains the variable which characterizes the energy input of the laser welding machine into the workpiece as a function of operating parameters of the laser welding machine is trained as a function of the ascertained number of spatters.

In particular, in accordance with an example embodiment of the present invention, it may be provided that the data-based model is trained to output this ascertained variable characterizing the energy input as the model output variable as a function of the operating parameters, the training of the data-based model taking place as a function of the number of spatters as the experimentally ascertained measured variable, and the training also taking place as a function of a simulatively ascertained variable characterizing the energy input as the simulatively ascertained simulation variable.

It may be advantageous to combine simulations and experiments for the training, since simulations may be carried out easily and quickly, but are often rather disadvantageous in their accuracy, whereas experiments do often have a high level of accuracy but are very complex to carry out.

This enables being able to carry out efficient and targeted optimization of the process parameters. The method of Bayesian optimization is used for this purpose. With the aid of this method, optima may be found in unknown functions. An optimum is characterized by target values q_{i,target} for one or multiple quality properties (features) qᵢ, which are specified by a user. Multiple quality properties may be offset in a so-called cost function K to obtain a single function to be optimized. This cost function also has to be predefined by the user. One example is the sum of scaled deviations with respect to the particular target value:

K=Σᵢ₌₁^{N}sᵢ|qᵢ−q_{i,target}| (1)

Parameters sᵢ are predefinable scaling parameters here. To find the optimum of the cost function, parameter sets for the next experiment may be provided by the application of the Bayesian optimization. After the experiment is carried out, the resulting values of the quality criteria and thus the present cost function value may be determined and provided as a data point to the optimization method jointly with the set process parameters.

The Bayesian optimization method is capable, for a function which maps a multidimensional input parameter space on scalar output values, of finding that input parameter set which results in the optimum starting value. Depending on the optimization goal, the optimum is defined here as the greatest possible or alternatively also the minimal achievable value which the function values may assume. In terms of process optimization, for example, the input parameter set is given by a specific set of process parameters; the starting value associated with it may be ascertained by the above-described cost function.

Because experiments have to be carried out and evaluated to determine the function values of the cost function, basically only a value table including data, which also have experimental “noise,” is available from the function. Because the experiments are very complex, this noise normally may not be suppressed by numerous repetitions with the same input parameter set using subsequent averaging of the results. Therefore, it is advantageous to carry out the optimization using a method which also enables global optimization with good results in spite of few experimental evaluations and manages without calculating gradients of the cost function. It has been recognized that Bayesian optimization meets these characteristics.

The Bayesian optimization involves the mathematical method of the Gaussian processes, with which a prediction of the most probable functional value including its variance results based on a given value table for each input parameter set, and on an algorithmically formulated specification for which input parameter set a further functional evaluation (i.e., in our case an experiment) is to be carried out, which is based on the predictions of the Gaussian process.

Specifically, the prediction for the result of the function evaluation in the case of an input parameter set x_{N+1} is given by the most probable value (“mean value”) of the Gaussian process

m(x_{N+1})=k^{T}c_{N}⁻¹t (2)

including the variance

σ²(x_{N+1})=c−k^{T}C_{N}⁻¹k (3)

Here, C_{N} means the covariance matrix, which is given by

[C_{N}]ₙₘ=k(xₙ,xₘ)+β⁻¹δₙₘ, where n,m=1 . . . N, (4)

xₙ and xₘ being parameters in the case of which a function evaluation has already taken place. Variable β⁻¹ represents the variance of the normal distribution, which stands for the reproducibility of experiments with identical input parameter, δₙₘ is the Kronecker symbol. Scalar c is conventionally given by c=k(x_{N+1},x_{N+1})+β⁻¹. Vector t contains the particular results for individual parameter sets xᵢ (i=1 . . . N) at which a function evaluation has taken place. So-called kernel function k(xₙ,xₘ) describes to what extent the result of the function evaluation in the case of a parameter set xₙ still has an influence on the result of the function evaluation in the case of a parameter set xₘ. Large values stand for a high level of influence, if the value is zero, no longer is there influence.

For the prediction of the mean value and the variance in the above formula, vector k, where [k]ᵢ=k(xᵢ,x_{N+1}), is calculated for this purpose with respect to all input parameter sets xᵢ (i=1 . . . N) and parameter set x_{N+1} to be predicted. For the kernel function to be used in the specific case, there are different approaches: the following exponential kernel represents a very simple approach:

k(xₙ,xₘ)=Θ₀ exp(−Θ₁∥xₙ−xₘ∥), (5)

including selectable hyperparameters Θ₀ and Θ₁. In this kernel, Θ₁ is decisive for the influence of the “distance” between the function values in the case of input parameters xₙ and xₘ, because the function goes to zero for large values of θ₁. Other kernel functions are possible.

The selection of the next parameter set at which an experiment is to be carried out is based on the predictions of mean values and variance calculated using the above formulas. Different strategies are possible here; for example, that of “expected improvement.”

In this case, that input parameter set is selected for the next experiment in which the expected value for finding a function value is greater (or less, depending on the optimization goal) than in greatest (or smallest, depending on the optimization goal) known functional value fₙ* from previous N iterations, thus

x_{N+1}=argmax E_{N}[[f(x)−f_{N}*]⁺] (7)

Such a function to be optimized is also referred to as an acquisition function. Other acquisition functions are possible, for example a knowledge gradient or an entropy search.

The “+” operator means here that only positive values are used and negative values are set to zero. In the Bayesian optimization,
a new experimental point (thus input parameter set) is now determined iteratively,
an experiment is carried out,
the Gaussian process is updated using the new function value, until the optimization is aborted.

The optimization of the Gaussian process using the new experimental point and the new function value takes place in such a way that the new pair made up of experimental point and function value is added to the already recorded experimental data made up of pairs of experimental points and function values, and the hyperparameters are adapted in such a way that a probability (for example, a likelihood) of the experimental data is maximized.

This process is illustrated in conjunction with FIG. 3.

A process model (depicted by the Gaussian process) may be built up successively by the iterative procedure of the above-described steps (carrying out an experiment, evaluating the quality criteria and determining the cost function value, updating the Gaussian process, and proposing the next parameter set). The best parameter set of all evaluated function evaluations or experiments is used as the best optimization result.

Advantages are obtained when carrying out the optimization by incorporating existing process knowledge. Knowledge in the form of one or multiple process models P_{1 . . . ,} may be incorporated into the optimization by the procedure described hereinafter, in that real experiments are complemented under certain conditions by simulation experiments. It is unimportant with which uncertainty the models depict the process and how many of the quality criteria they describe.

Any real experiment could be replaced by a simulation experiment using a process model which would perfectly depict the real experiment. If the evaluation duration were less than the real performance, time would also be saved in addition to the effort. In general, however, the prediction accuracy of the process models is limited. They are often only valid in a section of the parameter space and/or only describe a subset of the process results, and do not take into consideration all physical effects and therefore generate results only within an uncertainty band. In general, process models therefore may not replace physical experiments completely, but only partially.

In terms of the present invention described here, during each iterative optimization step, initially the process simulation models are called up which may predict a subset of the relevant features with a known accuracy. If it may also be precluded with sufficient certainty due to the predicted process result within the scope of the prediction accuracy that the process result will be close to the target values, an actual real experiment is not carried out. Rather, the results calculated using the process model are used here alternatively as an experimental result and the optimization process is continued.

If multiple process simulation models including a different prediction accuracy are available for different areas in the parameter space, in each case the one having the best prediction accuracy may be used.

Since as-described measured variable yₑₓₚ, as the number of spatters, and simulation variable yₛᵢₘ, for example as the energy input or a temperature, typically do not have the same physical units, it may furthermore be provided that one or both are transformed with the aid of an affine transformation.

The affine transformation in particular enables experiments and simulations to be combined for the training even if the measured variable and a physical variable simulated by the simulation variable are different physical variables and in particular even if these variables have different physical units.

In order that different measured and simulation variables may be combined with one another in the best possible manner, it may be provided that in the affine transformation, measured variable yₑₓₚ and/or simulation variable yₛᵢₘ is multiplied by a factor and this factor is selected as a function of a simulative model uncertainty σ_{P} and and as a function of an experimental model uncertainty σₑₓₚ.

If the factor is selected as a function of (in particular is equal to) the quotient of the simulative model uncertainty and the experimental model uncertainty, the possibility results of a particularly reasonable comparability of simulation variable and measured variable.

In one refinement of the present invention, it is provided that the data-based model includes a simulatively trained first partial model GP₀, in particular a Gaussian process model, and an experimentally trained second partial model GP_{V}, in particular a Gaussian process model, simulative model uncertainty σ_{P} being ascertained with the aid of first partial model GP₀ and experimental model uncertainty σexp being ascertained with the aid of second partial model GP_{V}. This enables a correct estimation of the experimental model uncertainty even if the simulatively trained first partial model is also combined with a further experimentally trained model in the data-based model to optimize the model accuracy.

The data-based model advantageously includes an experimentally trained third partial model GP₁, in particular a Gaussian process model, which is trained to output a difference between experimentally ascertained measured variable yₑₓₚ and an output variable μ_{P} of first partial model GP₀. Measured variables and simulation variables may thus be combined particularly well, in particular if they are contradictory.

Specific embodiments of the present invention are explained in greater detail hereinafter with reference to the figures.

### BRIEF DESCRIPTION OF THE DRAWINGS

FIG. 1 schematically shows a structure of a laser welding machine, in accordance with an example embodiment of the present invention.

FIG. 2 schematically shows a structure of a test stand, in accordance with an example embodiment of the present invention.

FIG. 3 shows a specific embodiment for operating the test stand in a flowchart, in accordance with the present invention.

FIG. 4 shows an example of a profile of simulated and measured and trained output variables over an operating variable.

FIG. 5 shows an example of a profile of further simulated and measured and trained output variables over an operating variable.

### DETAILED DESCRIPTION OF EXAMPLE EMBODIMENTS

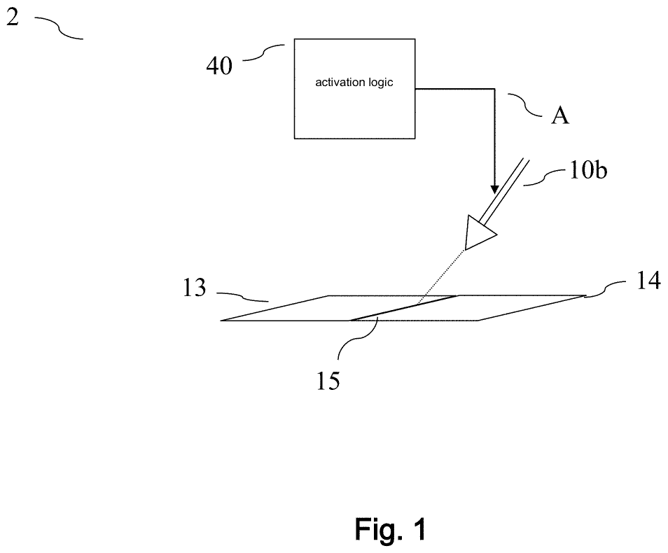

FIG. 1 schematically shows a structure of a laser welding machine 2. An activation signal A is provided by an activation logic 40 to activate a laser 10b. The laser beam strikes two material pieces 13, 14 where it generates a weld seam 15.

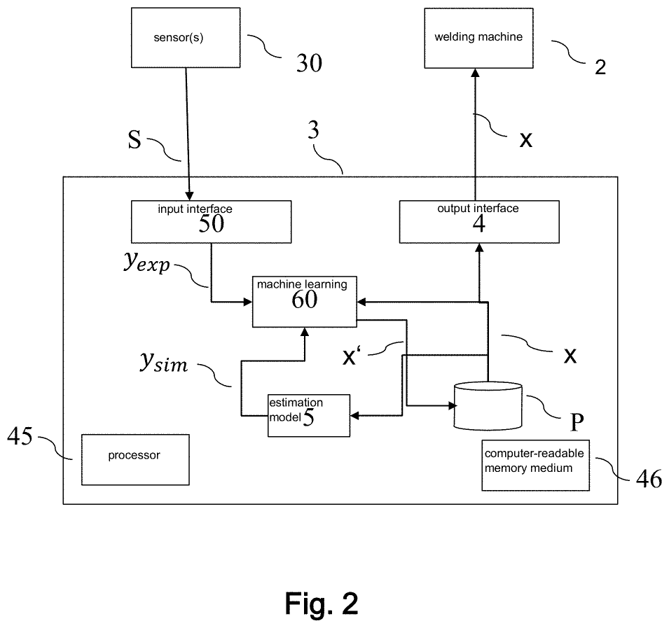

FIG. 2 schematically shows a structure of a test stand 3 for ascertaining optimal process parameters x. Present process parameters x are provided by a parameter memory P via an output interface 4 of laser welding machine 2. This machine carries out laser welding as a function of these provided process parameters x. Sensors 30 ascertain sensor variables S, which characterize the result of the laser welding. These sensor variables S are provided as quality properties yₑₓₚ to a machine learning block 60 via an input interface 50.

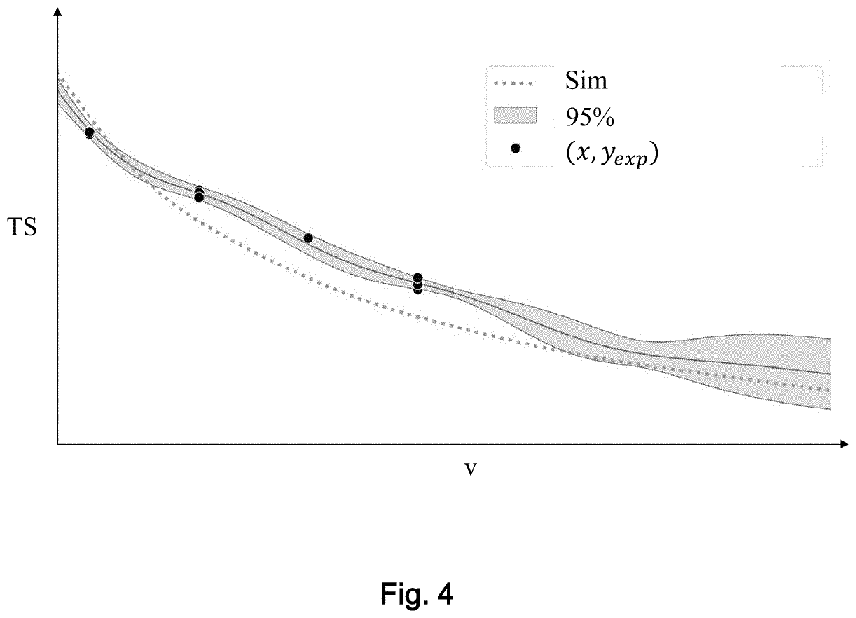

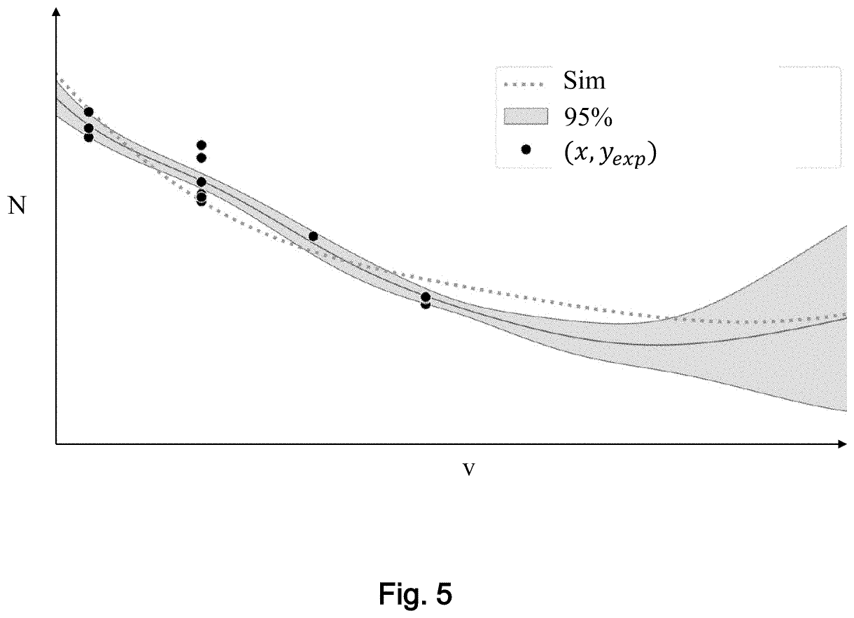

In the exemplary embodiment, machine learning block 60 includes a data-based model, which is trained as a function of provided quality properties yₑₓₚ, as illustrated in FIG. 4 and FIG. 5.

Varied process parameters x′ may be provided as a function of the data-based model, which are stored in parameter memory P.

Process parameters x may also, alternatively or additionally to the provision via output interface 4, be provided to an estimation model 5, which provides estimated quality properties yₛᵢₘ to machine learning block 60 instead of actual quality properties yₑₓₚ.

In the exemplary embodiment of the present invention, the test stand includes a processor 45 which is configured to execute a computer program stored on a computer-readable memory medium 46.

This computer program includes instructions which prompt processor 45 to carry out the method illustrated in FIGS. 4 and 5 when the computer program is executed. This computer program may be implemented in software or in hardware or in a mixed form of hardware and software.

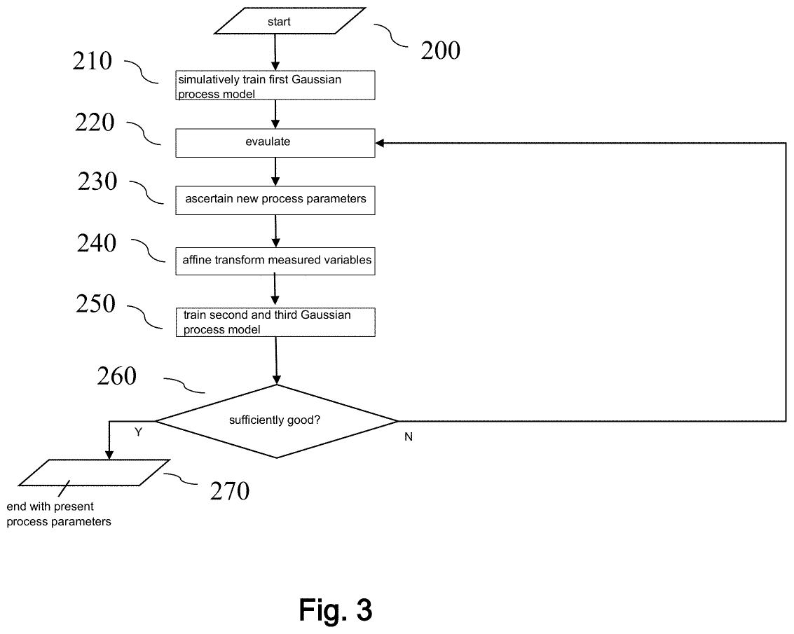

FIG. 3 shows a flowchart of a method for setting process parameters x of test stand 3. The method begins 200 in that a particular initialized first Gaussian process model GP₀, second Gaussian process model GP_{V}, and third Gaussian process model GP₁ are provided. The quantities of the previously recorded experimental data associated with the particular Gaussian process models are each initialized as an empty quantity.

Then 210, first Gaussian process model GP₀ is simulatively trained. For this purpose, initial process parameters xᵢₙᵢₜ are provided as process parameters x and optionally process parameters x are predefined using a design-of-experiment method and, as described in greater detail hereinafter, simulation data yₛᵢₘ associated with these process parameters x are ascertained and first Gaussian process model GP₀ is trained using the experimental data thus ascertained.

Using present process parameters x, a simulation model of laser welding machine 2 is executed and simulative variables yₛᵢₘ are ascertained 120, which characterize the result of the laser welding.

For this purpose, the ascertainment of estimated variables yₛᵢₘ may take place as follows, for example:

$$\begin{matrix}T ( x , y , z ) - {T}_{0} = \frac{1}{2 π λ h} exp ( - \frac{v ( x - {x}_{0} )}{2 a} ) ( \begin{matrix}{q}_{n e t} {K}_{0} ( \frac{vr}{2 a} ) + 2 {\sum }_{m = 1} cos ( \frac{m π z}{h} ) {K}_{0} \\ ( \frac{vr}{2 a} \sqrt{1 + {( \frac{2 m π a}{vh} )}^{2}} ) {l}_{m}\end{matrix} ) \\ where & ( 13 ) \\ r = \sqrt{{( x - {x}_{0} )}^{2} + {y}^{2}} & ( 14 ) \\ {I}_{m} = {\int }_{0}^{h} {q}_{1 n e t} ( z ) cos ( \frac{m π z}{h} ) dz & ( 15 )\end{matrix}$$

and the parameters
T₀—a predefinable ambient temperature;
x₀—a predefinable offset of the beam of laser 10b to the origin of a coordinate system movable with laser 10b;
λ—a predefinable heat conductivity of material pieces 13, 14;
a—a predefinable temperature conductivity of material pieces 13, 14;
qₙₑₜ—a predefinable power of laser 10b;
q₁ₙₑₜ a predefinable power distribution of laser 10b along a depth coordinate of material pieces 13, 14;
v—a predefinable velocity of laser 10b;
h—a predefinable thickness of material pieces 13, 14;
and Bessel function

$${K}_{0} ( ω ) = \frac{1}{2} {\int }_{- ∞}^{∞} \frac{{e}^{i ω t}}{\sqrt{{t}^{2} + 1}} d t$$

and an ascertained temperature distribution T(x,y,z). A width and a depth of the weld seam may be ascertained from the temperature distribution (for example via the ascertainment of isotherms at a melting temperature of a material of material pieces 13, 14). From the temperature distribution, an entire energy input may directly be ascertained, for example.

As a function of these variables, a cost function K is evaluated, as may be given, for example, by equation 1, variables yₛᵢₘ being provided as features qᵢ and corresponding target values of these variables q_{i,target}.

A cost function K is also possible which punishes deviations of the features from the target values, in particular if they exceed a predefinable tolerance distance, and rewards a high productivity. The “punishment” may be implemented, for example, by a high value of cost function K, the “reward” correspondingly by a low value.

It is then ascertained whether cost function K indicates that present process parameters x are sufficiently good; in the case in which a punishment means a high value and a reward means a low value in that it is checked whether cost function K falls below a predefinable highest cost value. If this is the case, the simulative training ends with present process parameters x.

If this is not the case, data point x,yₛᵢₘ thus ascertained made up of process parameters x and associated variables yₛᵢₘ characterizing the result is added to ascertained experimental data and first Gaussian process model GP₀ is retrained, thus hyperparameters Θ₀,Θ₁ of first Gaussian process model GP₀ are adapted in such a way that a probability that the experimental data arising from first Gaussian process model GP₀ is maximized.

An acquisition function is then evaluated, as illustrated by way of example in formula 7, and new process parameters x′ are hereby ascertained. The sequence then branches back to the step of evaluating the simulation model, new process parameters x′ being used as present process parameters x, and the method passes through a further iteration.

After completed simulative training of first Gaussian process model GP₀, subsequently evaluation is carried out using an acquisition function (220), as illustrated as an example in formula 7, and new process parameters x′, which are denoted hereinafter as xₑₓₚ, are ascertained 230 to experimentally train second Gaussian process model GP_{V} and third Gaussian process model GP₂. Laser welding machine 2 is activated using these process parameters xₑₓₚ, and measured variables yₑₓₚ are ascertained which characterize the actual result of the laser welding and the data-based model is trained using the experimental data thus ascertained as described hereinafter.

In this case, process parameters x include, for example, laser power resolved in a time-dependent and/or location-dependent manner via characteristic diagrams and/or a focus diameter and/or a focus position and/or a welding speed and/or a laser beam inclination and/or a circular path frequency of a laser wobble and/or parameters which characterize a process inert gas. Measured variables yₑₓₚ include, for example, variables which characterize, along weld seam 15, a minimal weld seam depth and/or a minimal weld seam width and/or the productivity and/or a number of weld spatters and/or a number of pores and/or a welding distortion and/or welding residual stress and/or welding cracks.

To train the data-based model using the ascertained pair made up of process parameters xₑₓₚ and measured variables yₑₓₚ initially the following variables are ascertained 230:
a simulative model uncertainty σ_{P} as the square root of variance σ² of first Gaussian process model GP₀ at point xₑₓₚ,
a simulative model prediction μ_{P} as the most probable value of first Gaussian process model GP₀ at point xₑₓₚ,
an experimental model uncertainty a σₑₓₚ as the square root of variance σ² of second Gaussian process model GP_{V} at point xₑₓₚ,
an experimental model prediction yₑₓₚ as the most probable value yₑₓₚ of third Gaussian process model GP₁ at point xₑₓₚ.

Measured variables yₑₓₚ are now each affine transformed 240 according to the following formula:

$${y}_{e x p} \to {y}_{e x p}^{a f f} = \frac{{σ}_{P}}{{σ}_{e x p}} \cdot ( {y}_{e x p} - {μ}_{e x p} ) + {μ}_{P} \qquad ( 16 )$$

Subsequently, second Gaussian process model GP_{V} and third Gaussian process model GP₁ are trained 250.

Second Gaussian process model GP_{V} is trained for this purpose with the aid of non-transformed measured variables yₑₓₚ, in that data point x,yₑₓₚ made up of process parameters x and associated measured variables yₑₓₚ is added to ascertained experimental data for second Gaussian process model GP_{V} and second Gaussian process model GP_{V} is retrained, thus associated hyperparameters Θ₀,Θ₁ of second Gaussian process model GP_{V} are adapted in such a way that a probability, that the experimental data result from second Gaussian process model GP_{V}, is maximized.

Third Gaussian process model GP₁ is trained for this purpose with the aid of affine transformed measured variables Vₑₓₚ^{aff}, in that data point x,yₑₓₚ^{aff} made up of process parameters x and associated affine transformed measured variables yₑₓₚ^{aff} is added to the ascertained experimental data for third Gaussian process model GP₁ and third Gaussian process model GP₁ is retrained, thus associated hyper parameters Θ₀,Θ₁ of third Gaussian process model GP₁ are adapted in such a way that a probability, that the experimental data result from third Gaussian process model GP₁, is maximized.

Similarly to the evaluation of cost function K in step 210, a further cost function K′ is then evaluated 160, as may result, for example, from equation 1, measured variables yₑₓₚ being provided as features qᵢ and corresponding target values of these variables q_{i,target}.

It is then ascertained (260) whether cost function K indicates that present process parameters x are sufficiently good. If this is the case (“yes”), the method ends 270 with present process parameters x.

If this is not the case (“no”), the sequence branches back to step 220.

FIGS. 4 and 5 show, by way of example for laser welding machine 2, a successfully trained data-based model including the first, second, and third Gaussian process model. FIG. 4 shows a depth ST of a weld seam as a function of velocity v of laser 10b, FIG. 5 shows a number N of spatters which occur during the welding process as a function of velocity v.

In each case, the output of the simulation model (dashed lines) used for the simulative training of first Gaussian process model GP₀, experimentally ascertained measuring points x,yₑₓₚ (black circles), model prediction μ as the most probable value of the data-based model (middle black line), and a prediction inaccuracy (95% confidence interval) of the data-based model (gray shaded area) are shown. FIG. 5 shows the successful training of the data-based model, although it was not possible to simulatively ascertain the experimentally ascertained measured variable of the number of spatters N. However, it has been found that the number of the spatters highly correlates with the simulatively ascertainable energy input, so that this simulatively ascertainable variable is used as simulation data.

To ascertain model prediction μ as the most probable value of the data-based model with predefined process parameters x, the sum of the model prediction of first Gaussian process model GP₀ and third Gaussian process model GP₁ is used and subsequently transformed using the inverse of formula 16, the parameters being ascertained similarly to step 230.

1-17. (canceled)

18. A method for training a data-based model to ascertain a variable which characterizes an energy input of a laser welding machine into a workpiece, as a function of operating parameters of the laser welding machine, the method comprising:
training the data-based model as a function of an ascertained number of spatters.

19. The method as recited in claim 18, wherein the data-based model is trained to output as a function of the operating parameters the ascertained variable characterizing the energy input as a model output variable, the training of the data-based model being carried out as a function of the number of spatters as an experimentally ascertained measured variable, and the training also being carried out as a function of a simulatively ascertained variable characterizing the energy input as a simulatively ascertained simulation variable.

20. The method as recited in claim 19, wherein during the training, the measured variable and/or the simulation variable are transformed using an affine transformation.

21. The method as recited in claim 20, wherein in the affine transformation, the measured variable and/or the simulation variable is multiplied by a factor, and the factor is selected as a function of a simulative model uncertainty and as a function of an experimental model uncertainty.

22. The method as recited in claim 21, wherein the factor is selected as a function of a quotient of the simulative model uncertainty and the experimental model uncertainty.

23. The method as recited in claim 21, wherein the data-based model includes a simulatively trained first partial model which is a Gaussian process model, and an experimentally trained second partial model which is a Gaussian process model, the simulative model uncertainty being ascertained using the first partial model, and the experimental model uncertainty being ascertained using the second partial model.

24. The method as recited in claim 23, wherein the data-based model includes an experimentally trained third partial model which is a Gaussian process model, and which is trained to output a difference between the experimentally ascertained measured variable and an output variable of the first partial model.

25. The method as recited in claim 24, wherein the second partial model is not trained with the transformed measured variable, but is trained using the measured variable.

26. The method as recited in claim 25, wherein the third partial model is trained using the transformed measured variable.

27. The method as recited in claim 24, wherein when ascertaining the transformed measured variable, the measured variable is transformed using the affine transformation, and the difference is multiplied by the factor.

28. The method as recited in claim 24, wherein to ascertain the model output variable of the data-based model, an output variable of the first partial model and an output variable of the third partial model are added and transformed using an inverse of the affine transformation.

29. The method as recited in claim 24, wherein to ascertain an uncertainty of the model output variable of the data-based model, the uncertainty is ascertained using the second partial model.

30. A method for setting operating parameters of a laser welding machine using Bayesian optimization of a data-based model, the method comprising the following steps:
training the data-based model as a function of an ascertained number of spatters; and
setting the operating parameters of the laser welding machine using the trained data-based model.

31. The method as recited in claim 30, wherein following the setting of the operating parameters, the laser welding machine is operated using the operating parameters thus set.

32. A test stand for a laser welding machine, the test stand configured to set operating parameters of the laser welding machine using Bayesian optimization of a data-based model, the test stand configured to:
train the data-based model as a function of an ascertained number of spatters; and
set the operating parameters of the laser welding machine using the trained data-based model.

33. A non-transitory machine-readable memory medium on which is stored a computer program for training a data-based model to ascertain a variable which characterizes an energy input of a laser welding machine into a workpiece, as a function of operating parameters of the laser welding machine, the computer program, when executed by a computer, causing the computer to perform the following:
training the data-based model as a function of an ascertained number of spatters.
